(19) United States
(12) Patent Application Publication
(10) Pub. No.: US 2017/0246628 A1
(43) Pub. Date: Aug. 31, 2017

(54) A METHOD AND DEVICE FOR CONCENTRATING PARTICLES IN A FLUID SAMPLE

(71) Applicant: Water Optics Technology PTE. Ltd, Singapore (SG)

(72) Inventors: Ai Qun LIU, Singapore (SG); Lei LEI, Singapore (SG); Shahnawaz PUKKEYIL SHAMSUDDIN, Singapore (SG)

(73) Assignees: Water Optics Technology PTE. Ltd, Singapore (SG); Water Optics Technology PTE. Ltd, Singapore (SG)

(21) Appl. No.: 15/519,792

(22) PCT Filed: Oct. 17, 2014
(86) PCT No.: PCT/SG2014/000491

§ 371 Date: Apr. 17, 2017

(51) Int. Cl. B01L 3/00; B01F 15/00; B01F 11/02; G01N 1/40; B01F 13/00

(52) U.S. Cl. CPC B01L 3/50273; B01L 3/502761; G01N 1/4077; B01F 13/0059; B01F 11/0266; B01F 15/0098; B01L 2400/0436; B01L 2200/0652; B01L 2400/086; B01F 2215/0073; B01F 2215/0052; B01F 2215/0037

(57) ABSTRACT

A microfluidic device and method is provided for concentrating particles in a fluid sample. The microfluidic device has a chamber, wherein the chamber has a filtering unit defining a first compartment and a second compartment, the first compartment being in fluid communication with the second compartment and being for receiving a fluid sample containing particles, the filtering unit being configured to selectively retain particles of the fluid sample based on a size of the particles, at a sub-region of the first compartment as the fluid sample flows from the first compartment to the second compartment; and an acoustic transducer configured to generate acoustic waves in the sub-region to disperse the particles.

### FIELD OF INVENTION

The invention relates to a method and device for concentrating particles in a fluid sample, and in particular, to a method and device for filtering and concentrating particles of interest in a fluid sample.

### BACKGROUND

There is a wide range of microbial species in drinking water that cause fatal outbreaks, including viruses, bacteria, protozoa and other particulates [1]. A fundamental limiting factor in the detection and quantification of these microorganism particles in drinking water is the very small number of each organism present and the interference between these microbial species. Therefore, in most detection techniques, preconcentration and filtration are essential prior to detection and quantification. A preconcentrator is a device which collects target samples (typically particles) from a fluid and ejects them on command to the next stage of treatment (e.g. detection and analysis) at a much higher concentration.

A consequence of this multi-step approach is that while there have been revolutionary developments in other steps of water testing (such as pathogen detection and quantification), the step of preconcentration and filtration remains a bottleneck of the whole process—if the target samples cannot be satisfactorily concentrated. This is especially important for developing a new generation of real-time on-chip detection systems in which only a small volume of water sample is employed. Without preconcentration, microorganism particles cannot be detected due to their low concentration. On the other hand, without a filtration or fractionation process, micro-sized microbials may clog the microchannel used to detect nano-sized biocontaminants and lead to the failure of the detection system. Therefore, the preconcentration and fractionation of microorganism particles are critical steps to facilitate the applied detection techniques.

Current preconcentration and fractionation techniques available are targeted at a specific category of biocontaminants. For protozoan parasites with size ranging from 3-65 μm, preconcentration is performed via membrane filtration with pore size of 2 μm [2, 3]. However, current available commercial filters have a low recovery rate (the ratio of the proportion of the particles of the sample collected after the preconcentration procedures as compared to before, which is typically expressed as a percentage of the initial value) ranging from 30-60%. In addition, the low porosity of the filters (10-25%) also leads to the low throughput of this technique. For bacteria, membrane filtration is commonly used for preconcentration and liquid culturing is employed for enrichment. Similarly, the membrane filtration technique has the limitations of low recovery rate and low throughput. Furthermore, the step of liquid culturing typically requires 1-2 days which slows down the overall detection cycle. The techniques for viral elution and enrichment suffer from the same limitations.

Other known techniques such as immunomagnetic separation [4, 5], gradient centrifugation [6, 7] and flow cytometry [8, 9] also have their own limitations as explained below.

A direct immunomagnetic separation technique requires the incubation of antibody-coated magnetic beads in the water sample. Targeted organisms are bound to the magnetic beads and separated from the rest of the suspension as a result of magnetic force. Accordingly, the efficiency of this technique is limited by the specificity and affinity of the antibody and the turbidity of water sample.

In gradient centrifugation, microbials are separated according to their specific densities. The recovery rate is low (30-40%) and only a relatively small sample volume can be processed.

Although flow cytometry has better sensitivity and specificity, it requires trained personnel to prepare the sample and operate the instrument. Furthermore, it has high operating and capital costs which has limited its use in water quality monitoring industry.

Therefore, there is a need for an improved method and system for particle concentration (especially preconcentration of water samples for quality monitoring purposes) with a high recovery rate, high throughput and high accuracy in fractionation.

### SUMMARY OF INVENTION

According to a first aspect, there is provided a microfluidic device comprising:

a chamber, wherein the chamber has a filtering unit defining a first compartment and a second compartment, the first compartment being in fluid communication with the second compartment and being for receiving a fluid sample containing particles, the filtering unit being configured to selectively retain particles of the fluid sample based on a size of the particles, at a sub-region of the first compartment as the fluid sample flows from the first compartment to the second compartment; and

an acoustic transducer configured to generate acoustic waves in the sub-region to disperse the particles.

By providing an acoustic transducer, acoustic waves can be generated to transmit energy to the fluid thereby agitating the fluid and particles at the sub-region to disperse the particles. This improves the recovery rate, concentration ratio and overall efficiency of the whole process. Firstly, the dispersal of the particles inhibits the filtration unit from being blocked. Secondly, at a time when the concentrated particles are to be extracted from the device (which is typically performed by creating a fluid flow from the second compartment to the first, a “backflush”), the acoustic waves detach the particles from the filtration unit.

Typically, the acoustic transducer is configured to generate acoustic waves in the sub-region to disperse the particles at a time when the fluid sample flows from the first compartment to the second compartment. This is advantageous since it would prevent the agglomeration of the particles and/or attachment of the particles to the filtering unit during the filtration/filtering process.

Alternatively or additionally, the acoustic transducer is configured to generate acoustic waves in the sub-region to disperse the retained particles upon a backflush of a fluid from the second compartment to the first compartment. In another embodiment, instead of creating a backflush by pumping fluid from the outlet, particles are collected by sucking the fluid (which contains the trapped particles) from the inlet. In both cases, the acoustic waves may be generated acoustic waves in the sub-region to disperse the retained particles prior to and/or during particle collection process.

This effectively disperses the retained particles near the filtering unit to reduce agglomeration of the particles and facilitates the detachment of the particles from the filtering unit for particles collection.

In one example, the acoustic transducer is an ultrasound transducer.

In one embodiment, the filtering unit comprises one or more projections extending into an interior space of the chamber. Typically, a plurality of projections are formed in a row perpendicular to a direction from the first compartment to the second compartment. This arrangement is advantageous because it helps increase the recovery rate. Recovery rate refers to the number of the particles collected after the concentration procedures (typically collected after the backflush) as compared to the initial number of the particles. The recovery rate is typically expressed as a percentage of the initial value. In addition, neighboring projections of the plurality of projections are separated by a gap. The gap has a neck defining the size of the largest particle which can pass through the filtering unit. The filtering unit can be easily obtained using standard lithographic techniques.

Preferably, the projections have longitudinal symmetry, such as in the direction transverse to the direction from the first compartment to the second.

In one embodiment, the projections are cuboid.

Optionally, a size of a cross-section of the projections, which is perpendicular to the direction from the first compartment to the second compartment, varies along the direction from the first compartment to the second.

Preferably, the gap between the neighboring projections widens towards the second compartment. In other words, the area of the cross-section decreases in that direction. This reduces the fluidic resistance experienced by the sample when it flows from the first to the second compartment while maintaining the ability of the filtering unit to effectively block particles exceeding a certain size. Advantageously, this reduces the likelihood of device failure as a result of the increased pressure due to the filtering unit. Furthermore, this increases the flow rate of the fluid and therefore improves the efficiency of the filtering and/or concentration process.

In one embodiment, the microfluidic device is a preconcentrator for preparing water samples for water quality monitoring. Typically, the particles are microorganism particles.

In other embodiments, the microfluidic device can be used for particle sorting (e.g. separating particles of different ranges of sizes from each other, rather than or in additional to particle concentration.

According to a second aspect of the invention, there is provided a method of concentrating particles in a fluid sample comprising steps of:

providing a microfluidic chamber having a first compartment in fluid communication with a second compartment;

introducing the fluid sample into the first compartment of the chamber;

selectively retaining particles based on a size of the particles, at a sub-region of the first compartment as the fluid sample flows from the first compartment to the second compartment; and

generating acoustic waves in the sub-region to disperse the particles.

Typically, the method has a further step of collecting the retained particles from the first compartment, for example, collecting the particles by creating a backflush in the chamber.

Typically, the fluid has a much higher particle concentration compared to that of the initial fluid sample, and the concentrated fluid may be ejected to the next stage of treatment if required.

Preferably, the method comprises generating acoustic-waves in the sub-region to disperse the particles at a time when the fluid sample flows from the first compartment to the second compartment.

Preferably, the method comprises creating a backflush of a fluid from the second compartment to the first compartment and generating acoustic waves to disperse the particles during the backflush.

According to a further aspect of the invention, there is provided a microfluidic device comprising:

a plurality of chambers, said plurality of chambers being in fluid communication,
wherein each of the plurality of chambers has a filtering unit defining a first compartment and a second compartment of the chamber; the first compartment of each chamber being in fluid communication with the corresponding second compartment and being for receiving a fluid sample containing particles,
the filtering unit being configured to selectively retain particles of the fluid sample based on a size of the particles, at a sub-region of the first compartment as the fluid sample flows from the first compartment to the second compartment; and

an acoustic transducer module configured to generate acoustic waves in the sub-region of each respective chamber to disperse the particles.

By “about” in relation to a given numerical value, such as for volume, concentration and period of time, it is meant to include numerical values within 10% of the specified value.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings. FIG. 1 is a schematic illustration of a microfluidic device according to an embodiment of the invention.

FIG. 2 which is composed of FIGS. 2(a) and 2(b), illustrates two exemplary configurations, (a) cuboid shape arid (b) waterdrop shape, of the projections of the filtering unit.

FIG. 3 which is composed of FIGS. 3(a)-3(d), schematically illustrates how an improved particle distribution (as viewed from a cross-section of the microfluidic device) is achieved with the presence of acoustic waves in the fluid ((c) and (d)), as compared to when no acoustic transducer is present ((a) and (b)).

FIG. 4 is a schematic illustration of a microfluidic device according to a further embodiment.

FIG. 5(a) is a photograph showing a top view of the filtering unit of the microfluidic device according to an embodiment of the invention.

FIG. 5(b) is a photograph of a cross-section of the filtering unit as viewed along the line A′-A′ in FIG. 5(a).

FIG. 6 shows statistical measurements of the recovery rate for preconcentrating C. parvum oocysts in water samples when using an embodiment of the present invention.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural changes may be made without departing from the scope of the invention. The various embodiments are not necessarily mutually exclusive, as some embodiments can be combined with one or more other embodiments to form new embodiments.

FIG. 1 shows a preferred embodiment of the invention. A microfluidic device 10 is provided with a chamber 12 for receiving and concentrating a fluid sample containing particles 20. The chamber 12 has an inlet 14 for receiving a fluid sample into the chamber 12 and an outlet 16 for discharging the sample. In this example, the particles 20 are microorganism particles.

The chamber 12 has a filtering unit 18 arranged between the inlet 14 and the outlet 16. The filtering unit 18 divides the chamber 12 into a first compartment 12a and a second compartment 12b and allows fluid communication between them. In this example, the filtering unit 18 divides the chamber 12 into two compartments of the same size.

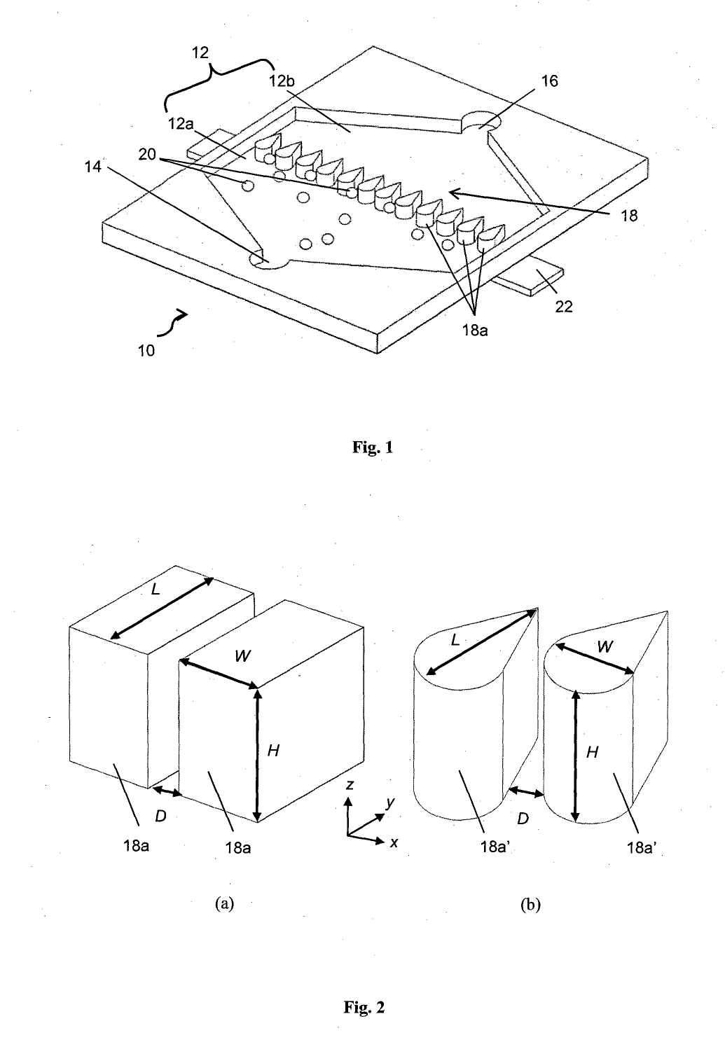

The filtering unit 18 has a plurality of projections (or “micropillars”) 18a extending up from a bottom surface of the chamber 12, and the micropillars 18a are formed in a row disposed across a width of the chamber 12. Each micropillar 18a of the array is spaced away from a neighboring micropillar 18a thereby leaving gap of between them. The gap defines a neck having a predefined distance D which effectively blocks particles which are larger than D (see FIG. 2). In this example, the row formed by the micropillars 18a is perpendicular to the direction of fluid flow from the first compartment 12a to the second compartment 12b to maximize the recovery rate of the particles.

FIG. 2 shows two examples of the shape and the arrangement of two neighboring micropillars. FIG. 2(a) shows two cuboid-shaped micropillars 18a. Since the width of the gap between the two micropillars 18a is D, particles 20 with a size larger than D flowing in the microchamber 12 will be blocked by the array of micropillars 18a. In this example, for a micropillar which is at an end of the row (i.e. for a micropillar which is adjacent to a side wall of the chamber 12), the distance between the wall of the chamber 12 and the neighboring micropillar 18 is also D. Generally, the distance D is no larger than 20 μm. Depending on applications, the distance D may be no larger than 10 μm, smaller than or equal to 5 μm, or even smaller than 3 μm. Typically, D takes a value between 0.1˜20 μm, 0.1˜10 μm, 0.5˜5 μm or any other ranges of size.

As known to a skilled person in the art, hydraulic resistance describes the difficulty with which a fluid can move through a space or fractures. The presence of the micropillar array in the chamber obstructs a part of the paths along which the fluid flows, which therefore increases the hydraulic resistance and results in a lower flow rate given a constant pressure gradient in the chamber. The hydraulic resistance at the gap between two micropillars can be expressed as

$$R ∝ \frac{12 η L}{{D}_{eff}^{3} H} , \qquad ( 1 )$$

where D_{eff} is the effective width of the gap, η is the viscosity of the fluid, H and L are the height and length of the micropillar, respectively. D_{eff} is the integration of the gap width along the length of the micropillar divided by the length, and expressed as

$${D}_{eff} = \frac{{\int }_{0}^{L} D ( y ) dy}{L} . \qquad ( 2 )$$

To reduce the resistance, the micropillar can be made with other shapes such as the waterdrop shape as shown in FIG. 2(b), rather than a cuboid shape. In this figure, the micropillars are labeled 18a′, rather than 18a. By restricting the smallest distance between two neighbouring micropillars 18a′ to D (in this case, the neck of the gap), the micropillars 18a′ can still efficiently block particles 20 whose size are larger than D while reducing the resistance experienced by the fluid. In other words, the portion of the gap downstream of the neck gradually widens towards the second compartment 12b. This in turn enables a higher flow rate to be achieved as compared to that of a filtering unit having the cuboid-shaped micropillars of a constant gap size of D. For example, for micropillars having a length (L) of 15 μm, a width (W) of 8 μm, a height (H) of 60 μm, and the gap (D) of 2 μm (as shown in FIGS. 2(a) and (b)), the hydraulic resistance between two waterdrop-shaped micropillars 18a′ (in FIG. 2(b)) is almost 100 times lower than that between the two cuboid-shaped micropillars 18a (in FIG. 2(a)).

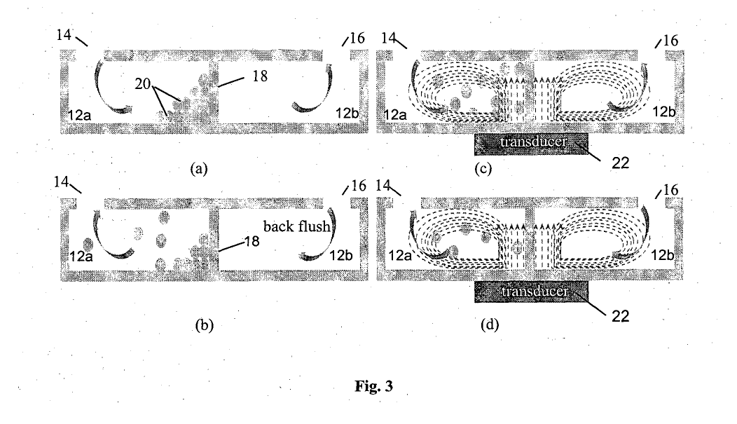

In use, the filtering unit selectively retains particles based the size of the particles. In this example, the minimum separation or neck D between the two neighboring micropillars 18a or 18a′ defines the maximum size of particles that is able to flow from the first compartment 12a to the second compartment 12b. Thus, the fluid together with smaller particles flows to the second compartment 12b and to the outlet 16. On the other hand, particles 20 having a size larger D are blocked by the array 18 of micropillars. The particles are collected retained and accumulated at a sub-region of the first compartment 12a nearby the array 18 of micropillars as the fluid sample flows from the first compartment 12a to the second compartment 12b. The retained particles are typically collected using a backflush process in which the retained particles 20 are flushed out from the inlet 14 by a fluid flow introduced into the outlet 16 as shown in FIG. 3b. During a typical backflush process, a small amount of fluid is made to flow from a second compartment 12b to a first compartment 12a passing through the filtering unit 18 thereby moving the particles 20 towards the inlet 14 of the chamber 12b for collection. Note that the collected fluid containing the particles 20 will therefore typically have a much higher concentration than of the fluid sample prior to running through the chamber 12. The backflush process may use the fluid that just emerged from the outlet 16 during the filtration process, or any other solutions (e.g. deionized water). The preconcentration factor refers to the ratio of the concentration of particles in the final sample solution (typically collected from backflush) ready, for its next stage treatment and the concentration of particles in the initial fluid sample prior to concentration. The preconcentration factor depends on the volume of the chamber 12 of the microfluidic device 10, since the minimum volume of concentrated sample is typically the same as the volume of the chamber 12. For example, if 1 liter of fluid sample with an initial concentration of target particles of 1 particle/mL is run through the chamber having a volume of 0.02 mL, the preconcentration factor is up to 50,000. That is, after 1 L of the fluid sample flows through the chamber 12 with the filtering unit 18, the blocked particles 20 (i.e. 1000 particles) are flushed out by introducing 0.02 mL backflush flow into the chamber 12. Thus, the particle concentration can be as high as 50 particles /μL resulting in a preconcentration factor of up to 50,000.

However, in reality, the preconcentration efficiency may be affected by the number of particles. In particular, if a large quantity of particles are trapped, they may block the gaps between most of the micropillars 18a as shown in FIG. 3(a). In this case, the working flow rate will decrease quickly as a result of the increased hydraulic resistance, and the microfluidic device may break due to the high pressure. In addition, this may adversely affect the backflush process since the particles 20 may adhere or attach to the micropillars 18a (especially under large pressure) and the large number of particles 20 may agglomerate thereby hindering the flow of backflush fluid to the first compartment 12a. Accordingly, the recovery rate may decrease. (see FIG. 3(b)).

To overcome this limitation, acoustic waves are generated in the chamber 12 to effectively disperse the retained particles 20 near the filtering unit 18 to reduce agglomeration of the particles and facilitate the detachment of the particles from the filtering unit 18 for particle collection. The acoustic waves agitate the fluid to induce “acoustic streaming”—a fluid flow resulting from the absorption of acoustic energy when an acoustic transducer continuously generates acoustic waves [10]. In this embodiment, an ultrasound transducer 22 is provided for agitating the fluid in the chamber 12. The acoustic streaming in the chamber 12 has two main functions: (1) dispersing the retained particles 20 to prevent or reduce agglomeration (FIG. 3(c)); (2) assisting the retained particles 20 to detach from the micropillars 18a during the backflush process (FIG. 3(d)). The ultrasound transducer 12 may generate localized streaming at regions where the particles are retained adjacent to the filtering unit 18. In one example, the ultrasound transducer 22 is positioned directly under the micropillars 18a (that is, such that a longitudinal axis of the micropillars intercepts the ultrasound transducer 22). In other embodiments, the ultrasound transducer 22 may be configured to agitate the fluid in other regions of the chamber 12 to disperse the retained particles 20 near the filtering unit 18. One or more ultrasound transducers may be used. A skilled person would also appreciate that other types of acoustic transducer may be used to agitate the fluid and generate “streaming” as appropriate.

The microfluidic device is useful for preparing water samples to be tested for biocontaminants, for example, for the purpose of monitoring of drinking water quality. In particular, the microfluidic device is able to process a large-volume water sample and concentrate waterborne pathogens into a much smaller volume of water. However, the device may be used to concentrate any other types of particles besides biocontaiminants or waterborne pathogens. A skilled person would appreciate that the device would work for any target particles and is also suitable for (or may be adapted for) concentrating target particles in other types of fluids, such as groundwater, wastewater, gas and oil. Generally, the length of the chamber (i.e. in the direction of from the first compartment to the second) may vary from 0.1˜10 cm, 0.5˜8 cm or 1˜4.5 cm. The width of the chamber (i.e. in a direction transverse to the length direction) may be 0.1˜10 cm, 0.5˜5 cm or 0.7˜3 cm. The height of the chamber (i.e. in the direction of the longitudinal axis of the micropillars) may be 1˜300 μm, 5˜200 μm, or 7˜400 μm. A skilled person would appreciate that the exact dimension of microfluidic device may vary or be adapted, for example, for specific purposes. Typically, the dimension of the microfluidic device with a single chamber is about 1˜5 cm in length, 1˜3 cm in width, and 10˜400 μm in height.

Furthermore, the device may be used for concentrating particles of different sizes or species (since different species may have very different sizes) of particles in a fluid sample.

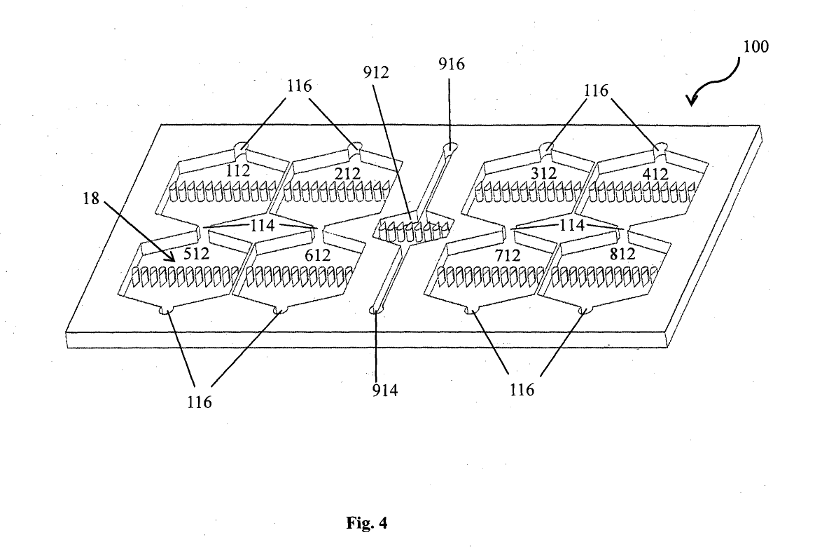

In one embodiment, as illustrated by FIG. 4, the microfluidic device 100 has four chambers 112, 212, 312, 412 for processing the fluid sample in parallel to speed up the concentration process. Each of the four chambers 112, 212, 312, 412 is in serial connection with each of another four chambers 512, 612, 712, 812, respectively. Each of the chambers may be the chamber 12 as described above. Each of the chambers 112, 212, 312, 412 has a respective inlet 114 and a respective outlet 116. Each of the chambers 512, 612, 712, 812 has a respective outlet 116 and each of them shares the inlet 114 of the respective chambers 112, 212, 312, 412. This again allows the fluid sample to be processed in parallel therefore speeding up the concentration process.

In another mode of use, a part of the respective inlet 114 may serve as an outlet for the respective chambers 512, 612, 712, 812 (and the fluid sample will be introduced into the outlet 116 of the chamber 512 and be configured to flow in the direction from chamber 512 to chamber 112). In this case, the respective chambers 512, 612, 712, 812 are configured to be in fluid communication in series with chambers 112, 212, 312, 412, respectively. In this case, one or more valves are typically included between chambers 112, 512 to control the flow of fluid through the inlet 114, for example, from chamber 512 to chamber 112 or the reverse. The valve may be provided within the inlet 114 itself. In this way, during a backflush, the valve between the two chambers 112, 512 is closed to allow the smaller particles to be stopped and collected at the inlet 116, instead of allowing them to flow back to the chamber 112. In use, the fluid may be made to flow from chamber 112 to chamber 512 to sort particles of different sizes. For example, a filtering unit of chamber 512 can be made to retain particles of a smaller size than those retained by a filtering unit of chamber 112.

In a further embodiment, the device has more than two chambers connected in series with each chamber having a filtering unit for retaining particles of a different size (for example, by having arrays of micropillars of different gap sizes) for sorting particles based on particle size.

The microfluidic device 100 may further have a ninth chamber 912 arranged in the center of the microfluidic device 100 located adjacent to the chambers 212, 312, 512, 612. Similarly, the ninth chamber 912 has an inlet 914 and an outlet 916 and a filtering unit across a width of the chamber 912. The chamber 912 and the other eight chambers described previously can be made to be in fluid communication via an external connector, such as by tubing with or without valves, such that the collected fluid (typically the concentrated fluid containing the target particles (i.e. the blocked particles)) from a “first-stage” chamber such as chambers 112, 212, 312, 412, 512, 612, 712, 812 can be introduced into a “second-stage” chamber 912 to perform a further round of concentration, if necessary. Of course, fluid sample which exits from the outlet 116 of the chamber 112 could also be introduced into the chamber 912 for particle sorting, if the filtering unit of chamber 912 is configured to block smaller particles than that of the chamber 112.

In the examples above, an acoustic transducer module (not shown) is provided for generating acoustic waves in the sub-region of each respective chamber to disperse the particles. It will be understood by a skilled person that there could be one or more acoustic transducer configured to generating acoustic waves thereby inducing streaming in each of the individual chambers or the plurality of chambers shares one or more acoustic transducers.

Each of the first stage chambers may have a higher volume than the corresponding second stage chamber (if there are more than one second stage chambers). According to a particular example, each of the first stage chambers 112, 212, 312, 412, 512, 612, 712, 812 has a volume of 0.2 mL and the second stage chamber has a volume of 0.08 mL.

It will be appreciated by persons skilled in the art that the present invention may also include further variations. For example, the acoustic transducers may or may not be physically attached to the microfluidic device to agitate the fluid in the chamber. For another example, the device may be provided with any number of chambers (be it first stage chambers or second stage chambers), not limited to the embodiments described above. In another embodiment, not all micropillars have an identical shape and/or identical gaps sizes between them. For a further example, the filtering unit may also have more than one row of micropillars. For yet a further example, the filtering unit may have a meshed or porous structure (the filtering unit 18 may contain any form of elements which defines an array of apertures), instead of being an array of micropillars. Each of the apertures has a minimal dimension D (in the case of array of micropillars, the “neck”) defining the size of the largest spherical particle which can pass through the filtering unit. The minimal dimension defined by each of the apertures is typically no larger than 20 μm. Depending on applications, the minimal dimension may be smaller than 10μm, smaller than 5 μm, or even smaller than 3 μm.

The microfluidic device may be fabricated from a silicon wafer using standard lithography processes, including oxide deposition, resist deposition, photolithography and development. In particular, the chamber may be formed by bonding two pieces of wafers together. In this example, a silicon wafer was used and various components of the chamber (e.g. the filtering unit, inlet, outlet, etc) were patterned by selectively etching portion of the wafer by a predefined depth, for example, a depth of 60 μm. Inlet and outlet holes were formed on a piece of glass wafer (Pyrex 7740) adapted to communicate with the inlet and outlet of the chamber when assembled. The holes can be formed by drilling, for example. Finally, the chamber is formed by applying thermal bonding to the patterned silicon wafer and the drilled glass wafer.

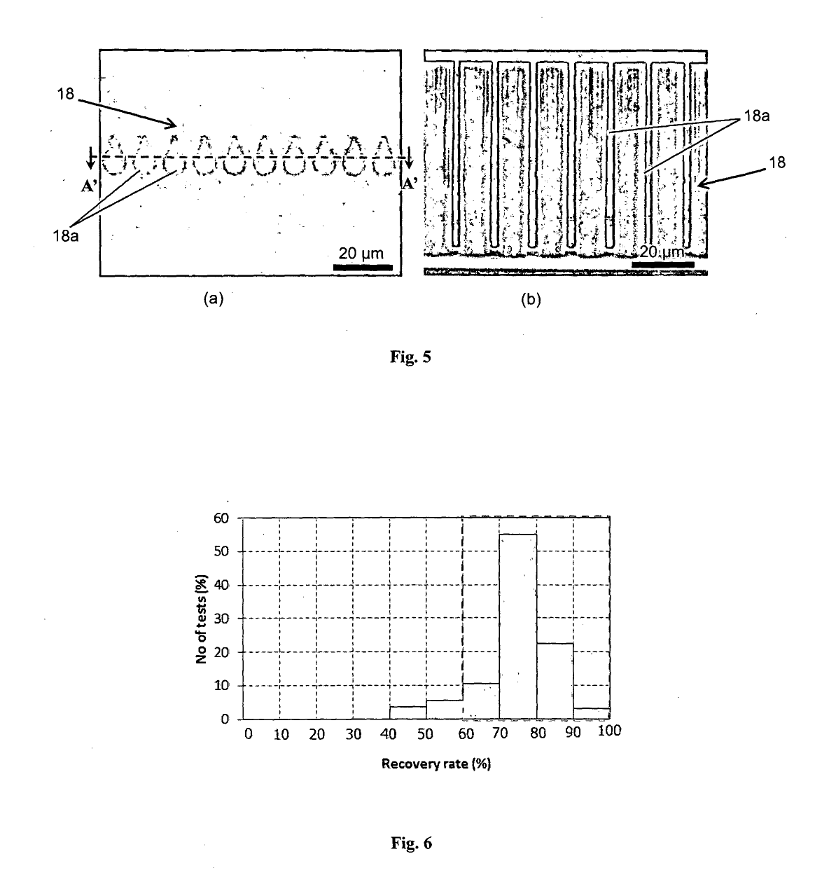

FIGS. 5(a) and 5(b) show the configuration and dimension of a filtering unit comprising an array of micropillars fabricated on a silicon wafer according to a particular example. As shown, each of the micropillars 18a has a waterdrop shape when viewed from the top. That is, a cross-section of the micropillar 18a has a waterdrop shape parallel to a major surface (such as the bottom surface) of the chamber 12.

In one example, the targeted particle is C. parvum oocyst (whose diameter ranges from 4 to 6 μm) and the gap between micropillars is set to 2.5 μm. The micropillars are formed in a one dimensional array (e.g. a row) with the same gap width between every two neighboring micropillars. In this example, the distance between a side wall of the chamber and its nearest micropillar is also 2.5 μm. A skilled person would appreciate that the distance may vary depending on specific applications. Typically, the range of the distance D is about 0.5˜5 μm or 0.5˜3 μm for the application of preconcentration of water samples.

In the embodiment shown in FIG. 3, the ultrasound transducer 22 is attached to an outer surface of the bottom wall of the chamber 12 and is placed directly below the row of micropillars 18. A typical working peak-to-peak voltage of the ultrasound transducer is 300 V, which generates acoustic wave with a frequency of 360 KHz in the chamber 12. The power and frequency of the acoustic wave generated should be high enough to disperse the particles without damaging the microfluidic device such as the micropillars. Typically, the power is about 1˜5 W, and the frequency is about 300 KHz. As explained earlier, the suspension or dispersal of particles is caused by the acoustic streaming, which is a fluid flow generated by the attenuation of an acoustic wave. As will be appreciated by a skilled person, streaming flows may vary greatly depending on the mechanism behind the attenuation of the acoustic wave, including viscosity of fluid, geometry and dimension of the chamber [10]. The suspending particles move due to the drag force induced by the acoustic streaming, which depends on the particle size and viscosity of fluid. A skilled person in the field would be able to determine the parameters of the acoustic waves by calculations and/or routine experiments.

### EXAMPLES

To perform preconcentration of a water sample using the device 100, 100 C. parvum oocysts are suspended in 10 L tap water and injected into the first stage chambers 112, 212, 312, 412, 512, 612, 712, 812 using a peristaltic pump (Masterflex, USA) with a flow rate of 500 mL/min. After 20 mins, all samples flow through the first stage chambers 112, 212, 312, 412, 512, 612, 712; 812 then the pump reverses its rotational direction and generates the backflush flow with a flow rate of 20 mL/min. The blocked particles are flushed out and collected from the inlets 114 of the first stage chambers 112, 212, 213, 412, 512, 612, 712, 812. The sample is concentrated into 25 mL after the first stage concentration. Thereafter, the concentrated sample is injected into the second stage chamber 912 with a flow rate of 5 mL/min. After further round of concentration in the second stage chamber 912, the sample volume is reduced into 0.2 mL.

In the above example, the parallel first stage chambers aim to decrease the processing time of large volume water samples. The second stage chamber aims to reduce the final sample volume by further concentrating the fluid sample to an even smaller volume. It will be understood that when introducing the sample into the microfluidic chamber, the flow rate and the volume of the fluid sample may be adjusted as desired by a skilled person. Similarly, when dispersing the particles during filtration or backflush, the power and frequency of the ultrasound transducer can be adjusted as desired by a skilled person.

In 100 times repeated preconcentration tests, the particle recovery rates are more than 60% in 90% of the tests as shown in FIG. 6. This has demonstrated the ability of the microfluidic device of the invention for large volume water sample preparation. By using the present device, 10 L water sample is reduced to be a small quantity solution, i.e. 200 μL, in 20 mins The particle recovery rate is more than 60% in 90% of the tests.

### REFERENCES CITED

The following references are hereby incorporated by reference in their entirety and for all purposes:
[1] World Health Organization, “Guidelines for drinking water quality,” 4th Edition, WHO Press, (2011).
[2] J. E. Ongerth and H. H. Stibbs, “Identification of Cryptosporidium oocysts in river water,” Appl. Environ. Microbiol. 53, 672 (1987).
[3] W. O. K. Grabow, A. Vrey, M. Uys and J. C. De Villiers, “Evaluation of the application of bacteriophages as indicators of water quality,” WRC Report No 540/1/98 (1998), Water Research, Commission, Pretoria.
[4] P. A. Chapman, D. J. Wright and C. A. Siddons, “A comparison of immunomagnetic separation and direct culture for the isolation of verocytotoxin-producing Escherichia coli O157 from bovine feces,” J. Med. Microbiol. 40, 424 (1994).
[5] T. Tomoyasu, “Improvement, of the immunomagnetic separation method selective for Escherichia coli O157 strains,” Appl. Environ. Microbiol. 64, 376 (1998).
[6] A. Böyum “Isolation of mononuclear cells and granulocytes from human blood. Isolation of monuclear cells by one centrifugation, and of granulocytes by combining centrifugation and sedimentation at 1 g,” Scand. J. Clin. Lab. Invest. Suppl. 97, 77 (1968).
[7] J. A. Wyber, J. Andrews, P. Gilbert, “Loss of salt-tolerance and transformation efficiency in Escherichia coli associated with sub-lethal injury by centrifugation,” Lett. Appl. Mirobiol. 19, 312 (1994).
[8] G. Vesey, N. Ashbolt, E. J. Fricker, D. Deere, K. L, Williams, D. A. Veal and M. Dorson, “Detection of specific microorganisms in environmental samples using flow cytometry,” Methods Cell Biol. 42, 489 (1994).
[9] D. Deere, G. Vesey, N. Ashbolt and M. Gauci; “Flow cytometry and cell sorting for monitoring microbial cells,” Encyclopaedia of Environmental Microbiology (New York, 2002).
[10] M. Wiklund, R. Green and M. Ohlin, “Acoustofluidics 14: Applications of acoustic streaming in microfluidic devices,” Lab Chip 12, 2438 (2012).

1. A microfluidic device comprising:
a chamber, wherein the chamber has a filtering unit defining a first compartment and a second compartment, the first compartment being in fluid communication with the second compartment and being for receiving a fluid sample containing particles, the filtering unit being configured to selectively retain particles of the fluid sample based on a size of the particles, at a sub-region of the first compartment as the fluid sample flows from the first compartment to the second compartment; and
an acoustic transducer configured to generate acoustic waves in the sub-region to disperse the particles.

2. The microfluidic device according to claim 1, wherein the filtering unit comprises one or more projections extending into an interior space of the chamber.

3. The microfluidic device according to claim 2, wherein the filtering unit comprises a plurality of projections formed in a row perpendicular to a direction from the first compartment to the second compartment, neighboring projections of the plurality of projections being separated by a gap.

4. The microfluidic device according to claim 3, wherein the projections have longitudinal symmetry.

5. The microfluidic device according to claim 4, wherein the projections are cuboid.

6. The microfluidic device according to claim 3, wherein a size of a cross-section of the projections varies along the direction, said cross-section being perpendicular to the direction.

7. The microfluidic device according to claim 3, wherein the gap between the neighboring projections widens towards the second compartment thereby reducing a hydraulic resistance of the filtering unit as the fluid flows from a first compartment to a second compartment.

8. The microfluidic device according to claim 1, wherein the acoustic transducer is configured to generate acoustic waves in the sub-region to disperse the particles at a time when the fluid sample flows from the first compartment to the second compartment.

9. The microfluidic device according to claim 1, wherein the acoustic transducer is configured to generate acoustic waves in the sub-region to disperse the retained particles upon a backflush of a fluid from the second compartment to the first compartment.

10. The microfluidic device according claim 1, wherein the particles comprises microorganism particles.

11. The microfluidic device according to claim 1, wherein the acoustic transducer is an ultrasound transducer.

12. A method of concentrating particles in a fluid sample comprising steps, of:
providing a microfluidic chamber having a first compartment in fluid communication with a second compartment;
introducing the fluid sample into the first compartment of the chamber;
selectively retaining particles based on a size of the particles, at a sub-region of the first compartment as the fluid sample flows from the first compartment to the second compartment; and
generating acoustic waves in the sub-region to disperse the particles.

13. A method according to claim 12, wherein the method further comprises collecting the retained particles from the first compartment.

14. A method according to claim 12 further comprising generating acoustic waves in the sub-region to disperse the particles at a time when the fluid sample flows from the first compartment to the second compartment.

15. A method according to claim 12 further comprising creating a backflush of a fluid from the second compartment to the first compartment and generating acoustic waves to disperse the particles during the backflush.

16. A microfluidic device comprising:
a plurality of chambers, said plurality of chambers being in fluid communication,
wherein each of the plurality of chambers has a filtering unit defining a first compartment and a second compartment of the chamber, the first compartment of each chamber being in fluid communication with the corresponding second compartment and being for receiving a fluid sample containing particles,
the filtering unit being configured to selectively retain particles of the fluid sample based on a size of the particles, at a sub-region of the first compartment as the fluid sample flows from the first compartment to the second compartment; and
an acoustic transducer module configured to generate acoustic waves in the sub-region of each respective chamber to disperse the particles.
